(19) United States
(12) Patent Application Publication
(10) Pub. No.: US 2018/0053479 A1
(43) Pub. Date: Feb. 22, 2018

(54) METHOD AND SYSTEM FOR CONTROLLING DISPLAY OF A SPECIAL-SHAPED DISPLAY SCREEN

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: Lin LIN, Beijing (CN); Jian SUN, Beijing (CN); Wei SUN, Beijing (CN); Xue DONG, Beijing (CN); Dong CHEN, Beijing (CN); Rui XU, Beijing (CN)

(21) Appl. No.: 15/541,959

(22) PCT Filed: Jul. 14, 2016
(86) PCT No.: PCT/CN2016/089989

§ 371 Date: Jul. 6, 2017

(30) Foreign Application Priority Data
Jan. 25, 2016 (CN) 201610047785.7

(51) Int. Cl. G09G 3/36; G02F 1/1343; G02F 1/1362; G09G 3/20

(52) U.S. Cl. CPC G09G 3/3648; G09G 3/2088; G02F 1/136286; G02F 1/134309

(57) ABSTRACT

Provided in the embodiments of the present disclosure are a method for display control of a special-shaped display screen and a corresponding system. In the method, at least one cut area of the special-shaped display screen is determined, the cut area comprising data lines that are not connected to pixel units. When the at least one cut area is scanned, the data lines in the at least one cut area that not connected to pixel units are turned off and other data lines are turned on.

### TECHNICAL FIELD

The present disclosure relates to the field of display technology, and more particularly, to a method for controlling display of a special-shaped display screen and a corresponding system.

### BACKGROUND

This section is intended to inform the reader of the techniques of various aspects of the art that may be relevant to the various aspects of the present application, and it is believed that this section will help to provide background information to the reader in order to better understand the various aspects of the present application. It should be understood, therefore, that this should be interpreted from this perspective, rather than as a recognition of the prior art.

In general, a special-shaped display screen refers to a display device that has a non-rectangular shape. Usually, the shape of the special-shaped display screen can be viewed as a result of cutting a rectangle. However, the number of data lines and scanning lines in the special-shaped display screen is still consistent with the number of data lines and scanning lines of a display screen having the shape of its external rectangle. In other words, although data is still being transmitted on the data lines within the cut area of the special-shaped display screen, such data is not used for display.

For example, in a special-shaped display screen having a letter “I” shape as shown in FIG. 1, the number of data lines is the same as the number of data lines of a display screen having the shape of its external rectangle. In FIG. 1, Area 1 and Area 3 are regular display areas in which data lines are connected to pixels. Area 2 is a cut area in which only data lines of width W are connected to pixels to display images, and data lines (shown in the figure as dashed lines) of cut areas in the two cutting sides are provided in Area 2 in a bent wiring manner. Since these data lines are not connected to pixels, the transmitted data is not used for display images. Thus, transmitting data on data lines that are not connected to pixels may cause resource and energy wastes for operation and control logics of a source-driven integrated circuit (IC).

Although an existing triple gate line structure can reduce the number of leads of data lines to a certain extent, the number of the data lines is still large, requiring a lot of pins of the source-driven integrated circuit (IC). In addition, when these data lines are driven to transmit RGB pixel data of an image, the huge amount of image data occupies most of the resources such as timing unit of the IC, data monitoring unit thereof, and the like. In addition, a large amount of data processing leads to a large power consumption of the source-driven integrated circuit.

### SUMMARY

In exemplary embodiments of the present disclosure, a method and system for controlling display of a special-shaped display screen are provided. The embodiments of the present disclosure can reduce power consumption of a source-driven integrated circuit.

According to an aspect of the present disclosure, there is provided a method for controlling display of a special-shaped display screen. In the method, at least one cut area of the special-shaped display screen is determined, wherein the cut area comprises data lines that are not connected to pixel units. Thereafter, the data lines that not connected to pixel units are turned off and other data lines are turned on in the at least one cut area, when the at least one cut area is scanned.

According to an exemplary embodiment of the present disclosure, the method further comprises: determining at least one regular display area of the special-shaped display screen, and turning on all the data lines in the at least one regular display area, when the at least one regular display area is scanned.

According to an exemplary embodiment of the present disclosure, the method further comprises setting a control flag for the at least one cut area. In response to detection of the control flag, the data lines that are not connected to pixel units in the corresponding cut area are turned off and other data lines are turned on.

According to an exemplary embodiment of the present disclosure, the method further comprises counting the scanning of the special-shaped display screen. In response to the counting value being in at least one threshold range corresponding to the at least one cut area, the data lines that are not connected to pixel units in the corresponding cut area are turned off and other data lines are turned on.

According to an exemplary embodiment of the present disclosure, the method further comprises setting a start flag and an end flag for display control. The scanning of the special-shaped display screen is started in response to detection of the start flag, and the scanning is stopped in response to detection of the end flag.

According to an exemplary embodiment of the present disclosure, the special-shaped display screen has an “I” shape and includes a first regular display area in an upper area, a second regular display area in a lower area, and an intermediate cut area between the first regular display area and the second regular display area.

According to an exemplary embodiment of the present disclosure, the first regular display area comprises m1 scanning lines, n data lines and m1×n pixel units, the intermediate cut area comprises m2 scanning lines, n data lines, and m2×W pixel units, and the second regular display area comprises m3 scanning lines, n data lines and m3×n pixel units. n−W data lines that are not connected to pixel units are turned off and W data lines that are connected to the pixel units are turned on, when the intermediate cut area is scanned, where m1, m2, m3, n and W are positive integers.

According to an exemplary embodiment of the present disclosure, when the counting value of the scanning of the special-shaped display screen is more than or equal to m1+1 and less than or equal to m1+m2, n−W data lines that are not connected to the pixel units are turned off and W data lines that are connected to the pixel units are turned on.

According to another aspect of the present disclosure, there is provided a system for controlling display of a special-shaped display screen, wherein the special-shaped display screen comprises at least one cut area, the cut area comprises data lines that are not connected to pixel units. The system comprises a control unit configured to turn off the data lines that are not connected to pixel units and turn on other data lines in the at least one cut area when the at least one cut area is scanned.

According to an exemplary embodiment of the present disclosure, the special-shaped display screen further comprises at least one regular display area which is not the cut area.

The control unit is further configured to turn on all the data lines in the at least one regular display area when the at least one regular display area is scanned.

According to an exemplary embodiment of the present disclosure, the system further comprises a first flag setting unit configured to set a control flag for the at least one cut area. The control unit is further configured to detect the control flag, and to, in response to detection of the control flag, turn off data lines that are not connected to pixel units and turn on the other data lines in the corresponding cut area.

According to an exemplary embodiment of the present disclosure, the system further comprises a scanning counter configured to count the scanning of the special-shaped display screen. The control unit is further configured to determine whether the counting value of the scanning counter is in at least one threshold range corresponding to the at least one cut area, and to, in response to the count value being in the at least one threshold range, turn off the data lines that are not connected to pixel units and turn on other data lines in the corresponding cut area.

According to an exemplary embodiment of the present disclosure, the system further comprises a second flag setting unit and a third flag setting unit. The second flag setting unit is configured to set a start flag for display control. The third flag setting unit is configured to set an end flag for display control. The control unit is further configured to detect the start flag and the end flag, and to start the scanning of the special-shaped display screen in response to detection of the start flag, and, to stop the scanning in response to detection of the end flag. According to an exemplary embodiment of the present disclosure, the special-shaped display screen has an “I” shape and includes a first regular display area in an upper area, a second regular display area in a lower area, and an intermediate cut area between the first regular display area and the second regular display area. The first regular display area comprises m1 scanning lines, n data lines and m1×n pixel units, the intermediate cut area comprises m2 scanning lines, n data lines and m2×W pixel units, and the second regular display area comprises m3 scanning lines, n data lines and m3×n pixel units. The control unit is further configured to turn off n−W data lines that are not connected to the pixel units and turn on W data lines that are connected to pixel units when the intermediate cut area is scanned, wherein m1, m2 , m3, n and W are positive integers.

According to an exemplary embodiment of the present disclosure, the control unit is further configured to turn off n−W data lines that are not connected to the pixel units and turn on W data lines that are connected to the pixel units, when the counting value of a scanning counter that counts the scanning of the special-shaped display screen is more than or equal to m1+1 and less than or equal to m1+m2.

### BRIEF DESCRIPTION OF THE DRAWINGS

In order to illustrate the technical solutions of the embodiments of the present disclosure more clearly, the drawings accompanying the embodiments are simply introduced below. Obviously, the drawings in the following description merely relate to some embodiments of the present disclosure, rather than limiting the present disclosure.

FIG. 1 is a schematic diagram illustrating the wiring of data lines of a special-shaped display screen having an “I” shape;

FIG. 2 is a flow chart of a method for controlling display of a special-shaped display screen according to an embodiment of the present disclosure;

FIG. 3 is an exemplary schematic diagram explaining a partition of the special-shaped display screen having an “I” shape;

FIG. 4 is a schematic diagram illustrating a secondary partition of Area 2 (an intermediate cut area) in the partition shown in FIG. 3;

FIG. 5 is a conventional signal timing diagram for controlling display of a special-shaped display screen;

FIG. 6 is a signal timing diagram used in the method for controlling display of a special-shaped display screen according to an embodiment of the present disclosure;

FIG. 7 is a flow chart for explaining a process for controlling display of the special-shaped display screen as shown in FIG. 3;

FIG. 8 is a schematic block diagram of a system for controlling display of a special-shaped display screen according to an embodiment of the present disclosure.

### DETAILED DESCRIPTION

To make the purpose, technical solutions, and advantages of embodiments of the present disclosure more clear, the technical solutions of the embodiments of the present disclosure will be clearly and completely described below in conjunction with the drawings in the embodiments of the present disclosure. Obviously, the embodiments described are merely part of the embodiments of the present disclosure, instead of all of the embodiments.

Based on the embodiments of the present disclosure, all other embodiments obtained by those of ordinary skill in the art without creative work also fall within the scope of protection of the present disclosure.

In the following description, it should be noted that the orientation or position relationship indicated by the term “up”, “down”, “top”, or “bottom”, etc. is based on the orientation or position relationship shown in the drawings, for the purpose of illustration only, and should not be construed as indicating or implying that the device or element referred to must have a specific orientation and be constructed and operated in a particular orientation.

In addition, in the description of the embodiments of the present disclosure, “a plurality of” means two or more, unless otherwise specified.

Unless otherwise specified, in the embodiments of the present disclosure, turning on data lines means transmitting data on the data lines, and turning off data lines means not transmitting data on the data lines.

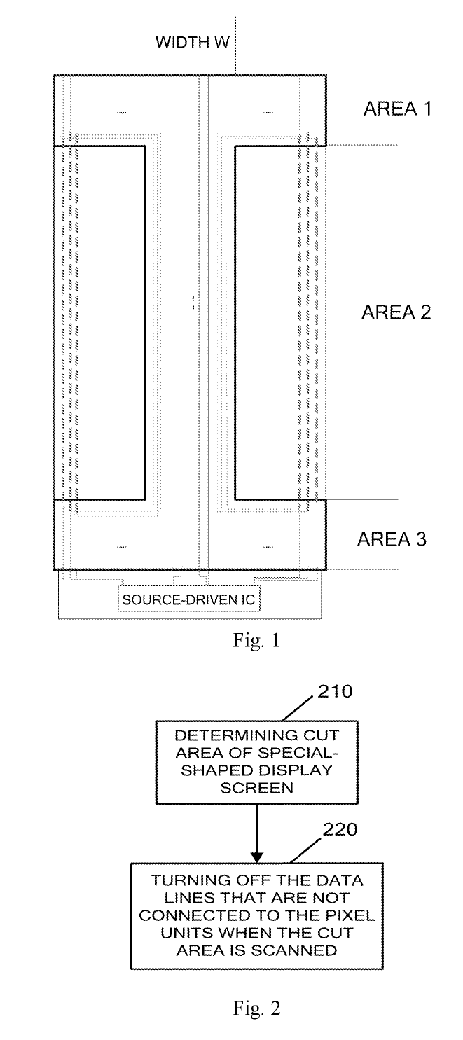

FIG. 2 is a flow chart showing a method for controlling display of a special-shaped display screen according to an embodiment of the present disclosure. As described above, the special-shaped display screen can be considered to be obtained by cutting an external rectangular display screen having an external rectanglar shape of the special-shaped display screen. The number of scanning lines and data lines of the special-shaped display screen is the same as the number of scanning lines and data lines of the external rectangluar display screen, but the number of pixel units of the special-shaped display screen is less than the number of pixel units of the external rectangluar display screen. Thus, in some areas of the special-shaped display screen, part of the data lines are not connected to pixel units.

As shown in FIG. 2, at step S210, at least one cut area of the special-shaped display screen is determined. In the present embodiment, the cut area refers to an area comprising data lines that are not connected to the pixel units. In other words, part of the data lines in the cut area are not connected to the pixel units. In addition, the cut area may also correspond to the remaining area after the external rectangular display screen is cut.

Then, at step S220, when the determined cut area is scanned, the data lines that are not connected to the pixel units are turned off and other data lines, i.e. data lines that are connected to the pixel units, are turned on in the cut area. In this way, data is not transmitted on the data lines that are not connected to the pixel units, and data is transmitted only on the data lines that are connected to the pixel units, so that the power consumption of a source-driven integrated circuit can be reduced.

In the embodiment of the present disclosure, it is also possible to determine at least one regular display area of the special-shaped display screen after step S210. The regular display area refers to an area that is not the cut area. In other words, the data lines in the regular display area are all connected to pixel units. Then, when the regular display area is scanned, all the data lines in the regular display area are turned on.

In the embodiment of the present disclosure, it is also possible to set a control flag for the determined cut area after step S210. The control flag may indicate the presence of the cut area to control the turning-off and turning-on of the data lines in the cut area and may also indicate the range of the cut area. For example, the range of the cut area may be represented by the number of scanning lines included in the cut area. When there are plurality of cut areas, a control flag may be provided for each cut area.

During the scanning of the special-shaped display screen, in response to detection of a control flag is, it indicates the start of the scanning of the cut area. During the scanning of the cut area, data lines that are not connected to the pixel units in the cut area corresponding to the detected control flag are turned off while only data lines that are connected to the pixel units are turned on. If no control flag is detected by the end of the scanning of the cut area, it indicates the start of the scanning of the regular display area. In this way, all the data lines are turned on.

In an embodiment of the present disclosure, the scanning may also be counted since the scanning of the special-shaped display screen is started. In response to the counting value of the scanning being in a threshold range corresponding to the cut area, the data lines that are not connected to the pixel units in the corresponding cut area are turned off and only data lines that are connected to the pixel units are turned on. In this embodiment, the threshold range may be expressed as the number of rows of the start scanning lines and end scanning lines corresponding to the cut area.

In the embodiment of the present disclosure, it is also possible to set a start flag and an end flag for display control. The start flag may be configured to indicate the start of the scanning of the special-shaped display screen, and the end flag may be configured to indicate the end of the scanning of the special-shaped display screen. In this case, In response to detection of the start flag, the scanning of the special-shaped display screen is started. In response to detection of the end flag, the scanning of the special-shaped display screen is stopped.

During the scanning of the special-shaped display screen, it is possible to further determine whether the cut area is reached by detecting the control flag of the cut area or counting the scanning. When the cut area is scanned, data lines that are not connected to the pixel units in the cut area are turned off, and only data lines that are connected to the pixel units are turned on.

The method for controlling display of the special-shaped display screen according to the present embodiment can perform different display control on the cut area and regular display area of the special-shaped display screen. In this way, during the scanning of the cut area, data lines that are not connected to the pixel units are turned off, and only data lines that are connected to the pixel units are turned on. Therefore, the power consumption of the source-driven integrated circuit is reduced.

Hereinafter, an embodiment of the present disclosure will be further described in detail with reference to a special-shaped display screen having a letter “I” shape as an example.

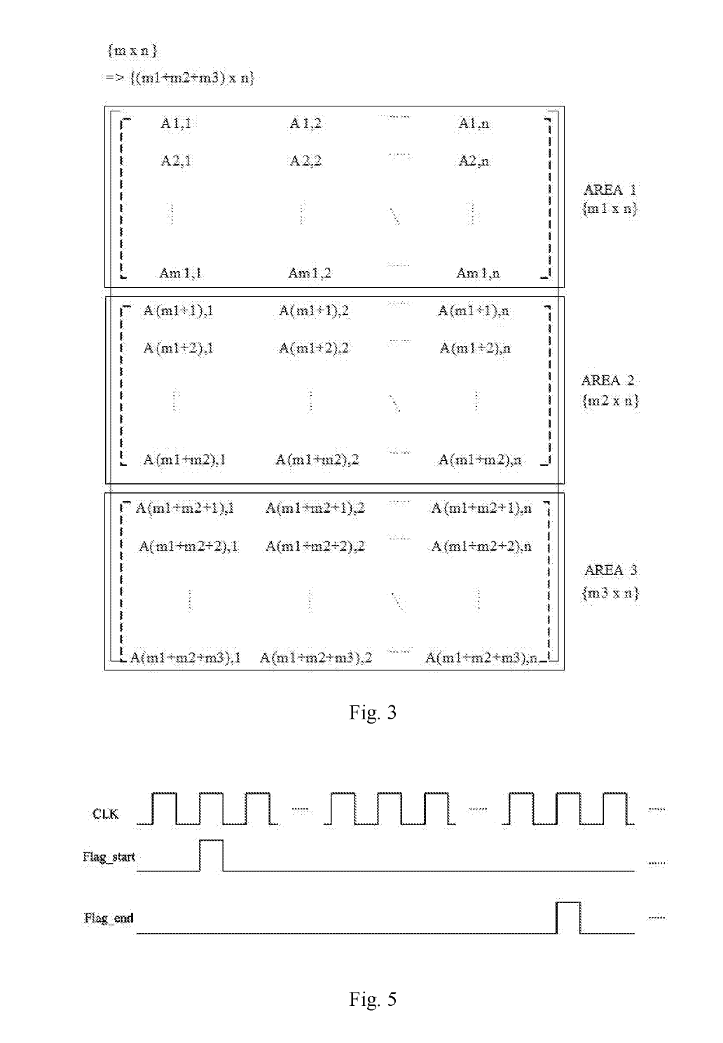

FIG. 3 exemplarily shows a partition of the special-shaped display screen having an “I” shape. Assume that the special-shaped display screen can be configured with m scanning lines and n data lines. As shown in FIG. 3, the special-shaped display screen may be configured with three areas: a first regular display area (shown as “Area 1”) in an upper area, an intermediate cut area (shown as “Area 2”) in a middle area, and a second regular display area (shown as “Area 3”) in a lower area. Area 1 comprises m1 scanning lines, n data lines and m1×n pixel units. Thus, all the data lines in Area 1 are connected to the pixel units. Area 2 comprises m2 scanning lines, n data lines and m2×W pixel units. Thus, in Area 2, only W data lines in the n data lines are connected to the pixel units and the remaining n−W data lines are not connected to pixel units. Area 3 comprises m3 scanning lines, n data lines and m3×n pixel units. Thus, all the data lines in Area 3 are connected to the pixel units. In the above example, m1, m2, m3, n and W are positive integers, and m=m1+m2+m3.

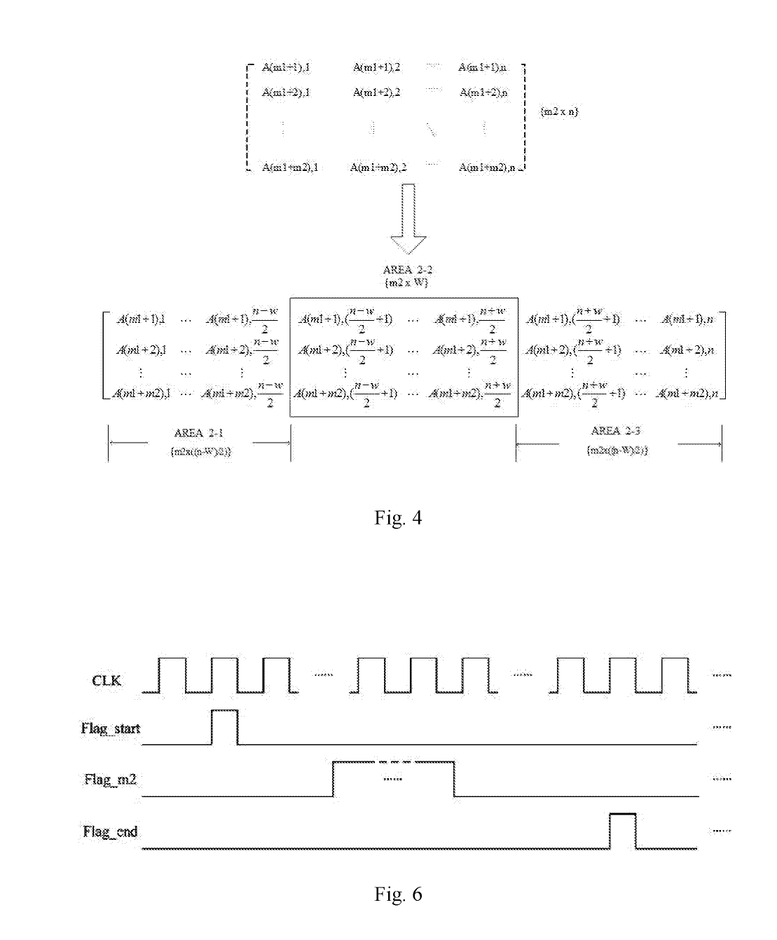

Further, in Area 2, Area 2 may be configured with an active imaging area and an inactive imaging area according to whether the data lines are connected to pixel units. The active imaging area can be referred to {m2×W}, where W represents the number of data lines in the active imaging area. Correspondingly, the inactive imaging area comprises n−W data lines. FIG. 4 exemplarily shows a secondary partition of Area 2 in the partition shown in FIG. 3. As shown in FIG. 4, Area 2 can be configured with an active imaging area 2-2 and inactive imaging areas 2-1 and 2-3, according to the shape of the special-shaped display screen. The size of the active imaging areas 2-1 and 2-3 is {m2×(n−W)/2}, and the size of the active imaging area 2-2 is {m2×W}. FIG. 5 shows a conventional signal timing diagram for controlling display of a special-shaped display screen. In FIG. 5, the start flag Flag_start is configured to indicate the start of the scanning of the special-shaped display screen, and the end flag Flag_end is configured to indicate the end of the scanning of the special-shaped display screen. Assume that the special-shaped display screen is an “I” special-shaped screen as shown in FIG. 3. In response to detection of the start flag Flag_start, that is, the start flag Flag_start is active (for example, Flag_start=1), the scanning of the special-shaped display screen is started, and all the data lines are turned on. In response to detection of the end flag Flag_end, that is, the end flag Flag_end is active (for example, Flag_end=1), the scanning of the special-shaped display screen is stopped and all the data lines are turned off. Thus, during the entire scanning, data lines that are not connected to the pixel units in Area 2 are still operating continuously, leading to resource and energy wastes of the source-driven integrated circuit.

Thus, in the embodiment of the present disclosure, the turning-on and turning-off of the data lines in the cut area can be further controlled by setting a control flag to the cut area. For example, the control flag may be a flag Flag_m2 that indicates an inactive imaging area. For the special-shaped display screen shown in FIG. 3, during a preprocessing stage (i.e., the stage for waiting to receive an image array), the number of rows of the macro variable image matrix, macro variable m, can be set to the number of scanning lines of the special-shaped display screen, the number of columns of the macro variable image matrix, macro variable n, can be set to the number of data lines of the special-shaped display screen, a partition macro variable Region can be set to the number of partitions of the special-shaped display screen, the inactive width macro variable Bypass can be set to the number of data lines that are not connected to pixel units in the cut area of the special-shaped display screen, the number of rows of the Area 1 image matrix, macro variables m1, can be set to the number of scanning lines in the first regular display area of the special-shaped display screen, and the number of rows of the Area 2 image matrix, macro variables m2, can be set to the number of scanning lines in the second regular display area. Therefore, the size of each partition is respectively as follows: {m1×n} for Area 1, {m2×n} for Area 2, and {m3×n} for Area 3, where m2 is the number of scanning lines in the cut area. In addition, the start flag Flag_start, the inactive imaging area flag Flag_m2, and the end flag Flag_end are initialized to zero.

FIG. 6 shows a signal timing diagram used in the method for controlling display of a special-shaped display screen according to an embodiment of the present disclosure.

When the start flag Flag_start=1, the scanning of the special-shaped display screen is started. Since the inactive imaging area flag Flag_m2=0, all the n data lines are turned on and the image data is transmitted. When the inactive imaging area flag Flag_m2=1, it indicates that the scanning of the cut area Area 2 is started, and the data lines of the inactive imaging areas Area 2-1 and Area 2-3 of the cut area, S1, S2, . . . , S (nW)/2, S {(n+W)/2+1}, S {(n+W)/2+2}, Sn, are turned off. When the inactive imaging area flag Flag_m2=0, it indicates that the scanning of the cut area Area 2 is ended, and the data lines of the inactive imaging areas Area 2-1 and Area 2-3 are turned on. When the end flag Flag_end=1, the scanning of the scanning lines is ended.

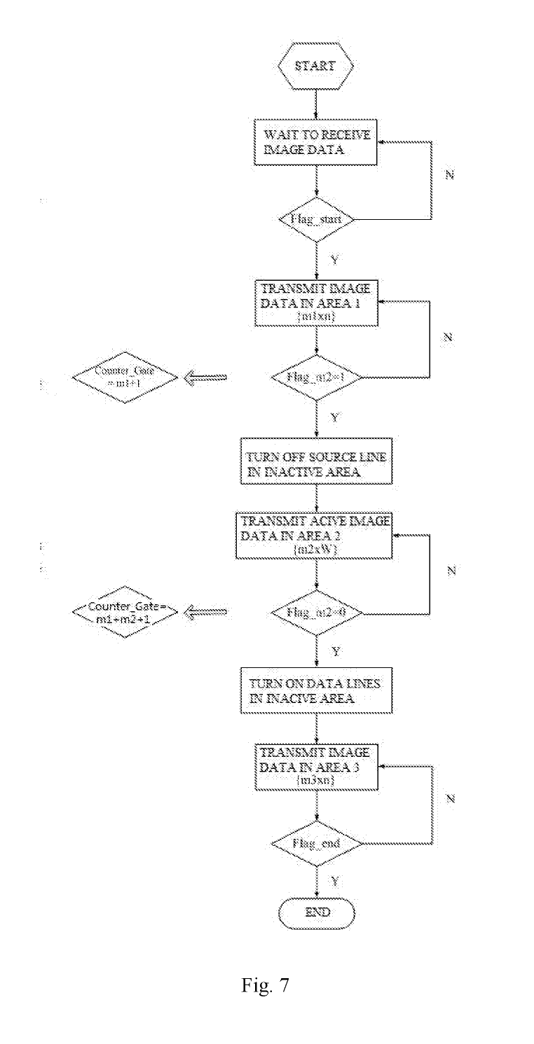

FIG. 7 exemplarily shows a process for controlling display of the special-shaped display screen as shown in FIG. 3.

As shown in FIG. 7, first, the special-shaped display screen waits to receive image data to enter the preprocessing stage. Then, it is determined whether the start flag Flag_start is active. In response to the start flag Flag_start being inactive, the preprocessing stage is maintained. In response to the start flag Flag_start being active, the scanning of the special-shaped display screen is started, and all the data lines are turned on to transmit the image data for image display in Area 1. Further, it is determined whether the inactive imaging area flag Flag_m2 is active. In response to the inactive imaging area flag Flag_m2 being inactive, all the data lines are turned on to transmit the image data. In response to the inactive imaging area flag Flag_m2 being active, the data lines in the corresponding inactive imaging area are turned off, and the data lines of the corresponding active imaging area are turned on to transmit the image data for image display in Area 2. Specifically, columns 1 to (n−W)/2 and columns (n+W)/2+1 to n of data lines are turned off, and columns (n−W)/2+1 to n (n+W)/2 of data lines are turned on. In response to the inactive imaging area flag Flag_m2 being inactive again, all the data lines are turned on to transmit the image data for image display in Area 3. Further, it is determined whether the end flag Flag_end is active. In response to the end flag Flag_end being active, the scanning of the special-shaped display screen is stopped and the transmission of the image data is ended.

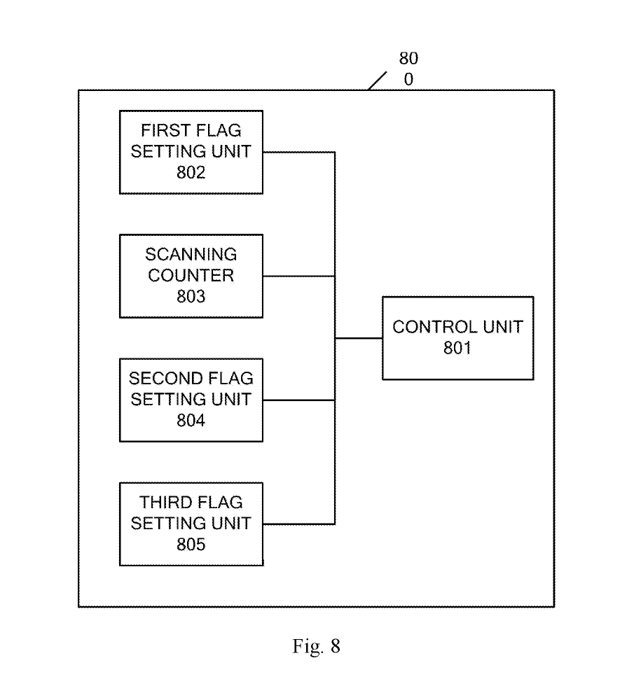

FIG. 8 is a schematic block diagram of a system 800 for controlling display of a special-shaped display screen according to an embodiment of the present disclosure. Hereinafter, the system 800 of the present embodiment will be described in detail with reference to the accompanying drawings, in which the description of the same parts as those of the foregoing embodiment are appropriately omitted.

In the present embodiment, the special-shaped display screen comprises at least one cut area, wherein the cut area comprises data lines that are not connected to pixel units. In addition, the special-shaped display may also comprise at least one regular display area that is not a cut area.

As shown in FIG. 8, the system 800 according to the embodiment of the present disclosure may comprise a control unit 801. When the cut area of the special-shaped display screen is scanned, the control unit 801 turns off the data lines that are not connected to the pixel units in the cut area and turns on other data lines that are connected to the pixel units. In addition, when the regular display area of the special-shaped display screen is scanned, the control unit 801 turns on all the data lines in the regular display area.

Further, in an embodiment of the present disclosure, the system 800 may further comprise a first flag setting unit 802 configured to set a control flag for each cut area of the special-shaped display screen. The control unit 801 may detect whether the control flag is active. In response to the control flag being active, the control unit 801 turns off the data lines that are not connected to the pixel units in the corresponding cut area and turns on the data lines that are connected to the pixel units in the cut area. In response to the control flag being inactive, the control unit 801 turns on all the data lines.

Further, in an embodiment of the present disclosure, the system 800 may further comprise a scanning counter 803 configured to count the scanning of the special-shaped display screen. The control unit 801 may further determine whether the counting value of the scanning counter 803 is in the threshold range corresponding to the cut area. In response to the counting value of the scanning counter 803 being in the threshold range, the control unit 801 turns off the data lines that are not connected to the pixel units in the corresponding cut area and turns on other data lines that are connected to the pixel units. In response to the counting value of the scanning counter 803 being out of the threshold range, the control unit 801 turns on all the data lines.

Further, in an embodiment of the present disclosure, the system 800 may further comprise a second flag setting unit 804 and a third flag setting unit 805. The second flag setting unit 804 may be configured to set the start flag Flag_start for display control. The third flag setting unit 805 may be configured to set the end flag Flag_end for display control. The control unit 801 may further detect the start flag Flag_start and the end flag Flag_end. In response to detection of the start flag Flag_start being active, the control unit 801 starts the scanning of the special-shaped display screen. In response to detection of the end flag Flag_end being active, the control unit 801 stops the scanning of the special-shaped display screen.

It should be appreciated that the identification of the cut area can be achieved by setting, for example, the control flag of the inactive imaging area flag Flag_m2 and counting the scanning. Since the wiring of the data lines and scanning lines of the special-shaped display screen is determined, the cut area can be identified by the counting of the scanning lines. In this case, when the count value Counter_Gate of the line scanning counter reaches m1+1, it indicates that the scanning reaches the cut area Area 2, the data lines in Area 2 that are not connected to the pixel units are turned off, and only the data lines that are connected to the pixel units in Area 2 are turned on. When the counter value Counter Gate reaches m1+m2+1, it indicates that the scanning of Area 2 is completed.

In the method and system for controlling display of a special-shaped display screen according to the embodiments of the present disclosure, the special-shaped display screen is configured with partitions so as to perform display control separately. The special-shaped display screen may be first configured with a regular display area and a cut area, and then the cut area may be further configured with an active imaging area and an inactive imaging area, wherein the inactive imaging area comprises data lines that are not connected to the pixels. The data lines that are not connected to the pixels in the inactive imaging area are time-controlled so that the data lines in the inactive imaging area are turned off when the cut area is scanned, thereby reducing the workload of the source-driven integrated circuit and reducing the power consumption.

In addition, the method and system for controlling display of a special-shaped display screen according to the embodiments of the present disclosure can also be applied to different special-shaped display screen structures.

Although the foregoing embodiments have been described in detail taking a special-shaped display screen having a letter “I” shape as an example, it will be understood by those skilled in the art that the method and system for display control of the special-shaped display screen according to the embodiments of the present disclosure are applicable to special-shaped display screens having any shape.

The above description is only about specific embodiments of the present disclosure, but the scope of protection of the present disclosure is not limited thereto. Any changes or substitutions that may be readily conceivable to those skilled in the art within the technical scope of the present disclosure are intended to be encompassed within the scope of protection of the present disclosure. Accordingly, the scope of protection of the present disclosure is defined by the appended claims.

1. A method for controlling display of a special-shaped display screen, comprising:
determining at least one cut area of the special-shaped display screen, wherein the cut area comprises data lines that are not connected to pixel units; and
turning off the data lines that not connected to the pixel units and turning on other data lines in the at least one cut area, when the at least one cut area is scanned.

2. The method according to claim 1, further comprising:
determining at least one regular display area of the special-shaped display screen, which is not the cut area; and
turning on all the data lines in the at least one regular display area, when the at least one regular display area is scanned.

3. The method according to claim 1, further comprising:
setting a control flag for the at least one cut area;
wherein, in response to detection of the control flag, the data lines that are not connected to pixel units in the corresponding cut area are turned off, and the other data lines are turned on.

4. The method according to claim 1, further comprising:
counting the scanning of the special-shaped display screen;
wherein, in response to the counting value being in at least one threshold range corresponding to the at least one cut area, the data lines that are not connected to pixel units in the corresponding cut area are turned off, and the other data lines are turned on.

5. The method according to claim 1, further comprising:
setting a start flag and an end flag for display control;
starting the scanning of the special-shaped display screen in response to detection of the start flag; and
stopping the scanning in response to detection of the end flag.

6. The method according to claim 1, wherein the special-shaped display screen has an “I” shape and includes a first regular display area in an upper area, a second regular display area in a lower area, and an intermediate cut area between the first regular display area and the second regular display area.

7. The method according to claim 6, wherein the first regular display area comprises m1 scanning lines, n data lines and m1×n pixel units, the intermediate cut area comprises m2 scanning lines, n data lines, and m2×W pixel units, and the second regular display area comprises m3 scanning lines, n data lines and m3×n pixel units,
wherein n−W data lines that are not connected to the pixel units are turned off and W data lines that are connected to the pixel units are turned on, when the intermediate cut area is scanned.

8. The method according to claim 7, wherein when the counting value of the scanning of the special-shaped display screen is more than or equal to m1+1 and less than or equal to m1+m2, n−W data lines that are not connected to the pixel units are turned off and W data lines that are connected to the pixel units are turned on.

9. A system for controlling display of a special-shaped display screen, wherein the special-shaped display screen comprises at least one cut area, the cut area comprises data lines that are not connected to pixel units, the system comprising:
a control unit configured to turn off the data lines that are not connected to pixel units and turn on other data lines in the at least one cut area when the at least one cut area is scanned.

10. The system according to claim 9, wherein the special-shaped display screen further comprises at least one regular display area which is not the cut area,
wherein the control unit is further configured to turn on all the data lines in the at least one regular display area when the at least one regular display area is scanned.

11. The system according to claim 9, further comprising:
a first flag setting unit configured to set a control flag for the at least one cut area,
wherein the control unit is further configured to detect the control flag, and to, in response to detection of the control flag, turn off data lines that are not connected to pixel units and turn on the other data lines in the corresponding cut area.

12. The system according to claim 9, further comprising:
a scanning counter configured to count the scanning of the special-shaped display screen,
wherein the control unit is further configured to determine whether the counting value of the scanning counter is in at least one threshold range corresponding to the at least one cut area, and to, in response to the count value being in the at least one threshold range, turn off the data lines that are not connected to the pixel units and turn on the other data lines in the corresponding cut area.

13. The system according to claim 9, further comprising:
a second flag setting unit configured to set a start flag for display control; and
a third flag setting unit configured to set an end flag for display control;
wherein the control unit is further configured to detect the start flag and the end flag, and to start the scanning of the special-shaped display screen in response to detection of the start flag, and to stop the scanning in response to detection of the end flag.

14. The system according to claim 9, wherein the special-shaped display screen has an “I” shape and includes a first regular display area in an upper area, a second regular display area in a lower area, and an intermediate cut area between the first regular display area and the second regular display area.

15. The system according to claim 14, wherein the first regular display area comprises m1 scanning lines, n data lines and m1×n pixel units, the intermediate cut area comprises m2 scanning lines, n data lines and m2×W pixel units, and the second regular display area comprises m3 scanning lines, n data lines and m3×n pixel units,
wherein the control unit is further configured to turn off n−W data lines that are not connected to the pixel units and turn on W data lines that are connected to the pixel units when the intermediate cut area is scanned.

16. The system according to claim 15, wherein the control unit is further configured to turn off n−W data lines that are not connected to the pixel units and turn on W data lines that are connected to the pixel units, when the counting value of a scanning counter that counts the scanning of the special-shaped display screen is more than or equal to m1+1 and less than or equal to m1+m2.

17. The method according to claim 2, further comprising: setting a control flag for the at least one cut area;
wherein, in response to detection of the control flag, the data lines that are not connected to pixel units in the corresponding cut area are turned off, and the other data lines are turned on.

18. The method according to claim 2, further comprising:
counting the scanning of the special-shaped display screen;
wherein, in response to the counting value being in at least one threshold range corresponding to the at least one cut area, the data lines that are not connected to pixel units in the corresponding cut area are turned off, and the other data lines are turned on.

19. The system according to claim 10, further comprising: a first flag setting unit configured to set a control flag for the at least one cut area,
wherein the control unit is further configured to detect the control flag, and to, in response to detection of the control flag, turn off data lines that are not connected to pixel units and turn on the other data lines in the corresponding cut area.

20. The system according to claim 10, further comprising: a scanning counter configured to count the scanning of the special-shaped display screen,
wherein the control unit is further configured to determine whether the counting value of the scanning counter is in at least one threshold range corresponding to the at least one cut area, and to, in response to the count value being in the at least one threshold range, turn off the data lines that are not connected to the pixel units and turn on the other data lines in the corresponding cut area.
